(19) United States
(12) Patent Application Publication
(10) Pub. No.: US 2014/0325909 A1
(43) Pub. Date: Nov. 6, 2014

(54) Permeable Three Dimensional Multi-Layer Farming

(71) Applicant: Sadeg M. Faris, Pleasantville, NY (US)

(72) Inventor: Sadeg M. Faris, Pleasantville, NY (US)

(21) Appl. No.: 13/887,336

(22) Filed: May 5, 2013

(51) Int. Cl. A01G 31/06

(52) U.S. Cl. CPC A01G 31/06
USPC 47/62 R

(57) ABSTRACT

To achieve food and energy security a transformational three dimensional multilayer farming, multilevel farming (MLF) is required. This is path to eliminating the conflict of “food vs. biofuel” and achieving both food and energy security. However, this goal is only realizable if such 3D MLF systems are economically viable. Each layer in the MLF system comprises at least one string of SanSSoil Growth Elements each of which carries out multiple functions to sustain plant growth. In addition, all the layers comprise permeability features enabling sharing of resources to minimize the initial capital cost and the variable cost of consumables: i)—light permeable layers so that minimum artificial lights are used and shared throughout; ii) roots and shoots of plants in each layer share space of roots and shoots of adjacent layers achieving vertical space compression; and iii) the layers are permeable to nutrient fluids to minimize fluid delivery sources.

### RELATED APPLICATIONS

Not applicable.

### BACKGROUND OF THE INVENTION

1. Field of the Invention

This invention is related to the field of agriculture, horticulture, agronomy and agro-economics of food, energy, and other organism made substances. It is specifically related optimizing plant, yields, photosynthetic energy conversion efficiency as well as the utilization efficiencies of other resources, including, time, space, water, and nutrients. Even more specifically, the invention is related to indoor, environmental controlled farming in three dimensional, 3D, spaces, vertical farming, without the reliance on the sun energy or soil. It is also related to 3D farming systems comprising a plurality of layers each of which is capable of sustaining the growth of plants. More specifically, the plurality of layers is permeable in the sense they can pass through water, nutrients, light, shoot and roots of neighboring layers.

2. Description of Related Art

My Co-pending Application entitled “SanSSoil (Soil-less) Indoor Farming for Food and Energy Production”, is incorporated herein by reference in its entirety. This Application hereafter is referred to as “the First SanSSoil Application” or “FSA,” introduced more detailed background information expounding the limitations and liabilities of conventional soil-based agriculture. It presented inventive teachings of alternative soil-less indoor three dimensional multi-layer farming that are based on the Agriculture Profitability Assurance Law, AgriPAL, and the novel Plant Growth Model, PGM.

Together, AgriPAL and PGM present for the first time, mathematical analytical foundation, based of scientific principles, that describe how photosynthesis works, and presents formulas for predicting yield, energy efficiency, and agronomic profitability. They unraveled mysteries that to date eluded and baffled plant scientists and agronomists. They revealed the notion of solar gain, and astonishingly high physiological gains which can be garnered by means of better underrating of resource utilization efficiencies. These gains increase the yields and efficiencies by more than 10 fold and a path to approach and exceed 100 fold.

The FSA has inspired more transformational inventive contributions that are described in the present Application and subsequent related applications. The background, the formulas and the scientific teachings in FSA, is therefore relied upon heavily in the present application.

Will we Produce Enough Food to Adequately Feed the World?

Advances in health sciences and technologies, in combination with better nutrition, are paving the path to nearly eradicate infant mortality while increasing life spans to beyond the present average of 80 years. Consequently, it is expected that the world population will swell to at least 9 billion by 2050. It has been recognized that such a level of projected population increase will pose a formidable challenges to our planet, stressing its already limited resources: food, energy, land, and water, and fomenting acrimonious competition and conflicts, to obtain and sustain good quality of life and lifestyle.

These challenges have recently been highlighted by the United Nations' Food and Agriculture Organization, FAO, which published the findings of a High Level Experts Forum, in Rome, Oct. 12-13, 2009, entitled “How to Feed the World 2050”. Also in the Jun. 15, 2011 Issue, CO2-Science, published by the Center for the Study of Carbon Dioxide and Global Change, Dr. C. D. Idso, highlighted the challenges in his article entitled “Estimates of Global Food Production in the Year 2050: Will We Produce Enough to Adequately Feed the World?”

Both the FAO and Idso reports reveal an alarming consensus: that a significant per capita reduction is looming, in global food production, arable land, water resources, and farm yields of staple food crops. To avoid the disastrous consequences, they point to the need for a radical paradigm shift in food production technologies, systems and methods. The present food supplydemand gap continues to have devastating consequences in many parts of the world, in the forms of hunger, mal-nutrition, and deaths. According to FAO, there are 1 billion hungry people in 2012. The projected widening of that gap will worsen by 2050 for a 9 billion population. In addition to famine in many parts of the world, geopolitical strife will also cause incalculable adverse effects on the welfare of humanity.

These challenges are further magnified by the following three conflicts:

Conflict #1: Food Vs. Less CO2

There are many who are concerned over global warming caused by carbon dioxide emissions. They have embraced the cause of curbing fossil fuel use and are advocating CO2 reduction measures, and urging governments. They have influenced certain governments to act, and laws have been enacted attempting to discourage the use of resources that increase global CO2. However, this position is in direct conflict with the need to sustain life and to feed the world, as a first priority. At present, 1 billion hungry people need urgent attention, growing to be 3-4 billion in 2050. It is puzzling contradiction that the “global warming” community relies of questionable photosynthesis models to predict dire consequences for humanity in 2100, yet they cannot use the same models to understand why plant food efficiency is <0.5% (Table 1). The full and accurate understanding may very well prove that more CO2 is better at absorbing heat and at the same time deals with today's urgent need for food and biofuel. After all, CO2 is the main ingredient for food and life itself (living mass is hydrocarbon matter).

Conflict #2: Food Vs. Fuel

Direct consequences of the global warming mitigation are the mandates imposed by the US and EU and other countries to produce CO2 neutral transportation fuel from biomass, biofuel. This presents yet a second conflict with the priority of feeding the world. It is feared by many that biofuel exacerbates the problem by diverting already scarce resources normally dedicated to food production: arable land, water, seeds, fertilizers, herbicides, farming tools. The food and energy price pressures that ensue will make it even harder for many vulnerable segment of the global population to close the nutrition gap. It is feared that their numbers will increase. It is also in conflict with achieving both food and energy security. This food vs. fuel debate continues unabated: http://en.wikipedia.org/wiki/Food_vs._fuel

Conflict #3: Food Vs. Forest Land

As shown in Table 1, (http://arpae.energy.gov/Portals/0/Documents/ConferencesAndEvents/PastWorkshops/ABTF%20Workshop%20-%200rt%20Presentation.pdf) plant scientists, and agronomists agree that the measured efficiency is ˜0.5%, however, they cannot fully account for all the ˜99.5% losses, i.e., the where these losses originate. The full accounting for these losses is the key to inventing ways to minimize them.

Plants store solar energy in the form molecular bond energies of carbohydrates, sugars, starches, cellulose and proteins. The economics of conventional farming, to profitably produce generally affordable staple foods (sugars, cereal grains, legumes, leafy vegetable, and tubers such as: potato, yams, cassava), relies directly on the zero cost of solar energy, ZCOE. This forces cultivation outdoors, on two dimensional lands, because the solar radiation is delivered in units of Watt per unit area (hectares, acres, or square meters).

The reliance on this ZCOE has therefore, forced conventional agronomy to succumb to accepting ˜0.1 to 0.5% efficiencies (see Table 1). One of the main factors leading to such low efficiency is the need to use the soil to support plant growth, and soil borne nutrients which are not easily controlled. This lack of control makes soil a liability rather than an asset. The main concern breeder's have, when producing a new variety, is the specific environment (geography) and the soil mineral composition. This means instead of having one optimum seed that fits all, they will need produce an astonishingly large number of cultivar oaf particular species to serve as wide a market as possible. Even, then production cost constraints will require compromise. This is a consequence of uncontrolled outdoor soil based agriculture.

Therefore, because of the reliance on ZCOE, the growers, and the food production enterprises, have limited or no control. This in turn has lead to the requirement of enormous resources that are inefficiently used, including: insatiable demand for two dimensional arable land, water, fertilizers, and pesticides. To accommodate the population increase from 1 billion in 1800 to the present, ˜7 billion, required deforestation at a high rate. On a global scale, once again fearing that deforestation adversely impacts the issue of global warming, governments are enacting laws and mandates to restrict increasing farm land by deforestation. This is the third conflict with the priority to feed the world, and achieving energy security.

TABLE 1
Efficiencies of selected crops
Annual solar energy conversion efficiencies
of C3 and C4 agricultural crops.

| | | | Yield | Efficiency |
|---|---|---|---|---|
| | Crop | Type | t ha⁻¹y⁻¹ | (%) |
| Elephant grass | Pennistum purpureum | C4 | 88 | 0.8 |
| Sugar cane | saccharum officinarum | C4 | 66 | 0.6 |
| corn | zea mays | C4 | 27 | 0.4 |
| beet | beta vulgaris | C3 | 32 | 0.5 |
| rye | lolium perenne | C3 | 23 | 1.7 |
| potato | solanum tuberosum | C3 | 11 | 0.3 |

Farming Profitability and Economic Viability, AgriPAL

In my co-pending FSA, the formulation of Agriculture Profitability Assurance Law, AgriPAL, was presented and discussed extensively. It is repeated here as EQ. (2)

$${η}_{E} ( \frac{{ɛ}_{sol}}{{ɛ}_{other}} ) \frac{\overline{ROE}}{\overline{COE}} \geq ( 1 + p + f + v ) . \qquad ( 2 )$$

AgriPAL enables an enterprise to predict profitability of plant growing systems, to prices, and to identify efficiency bottlenecks.

The economic viability index, EVI, is defined as:

$$EVI ≡ {η}_{E} ( \frac{{ɛ}_{sol}}{{ɛ}_{other}} ) = {η}_{E} {g}_{solar} .$$

This links for the first time the economic parameters of farming, profit, p, fixed cost, f, variable cost, v, to the physiological parameters of organisms (plants, algae, other phototrophs), energy conversion efficiency, η_{E}, including a gain factor,

$${g}_{solar} = ( \frac{{ɛ}_{sol}}{{ɛ}_{other}} ) ,$$

wherein, εₛₒₗ, is the solar energy consumed per cycle and, εₒₜₕₑᵣ, all other energies consumed.

An enhanced EVI, was derived from the new Plant Growth Model, PGM, also described in FSA, is given by: EVI^{e}≡η_{E}^{e}≡gₑη_{E}. This increases the efficiency by yet another gain factor, gₑ, which can be 10-100, achieved by means of controlling and optimizing physiological growth parameters as well maximizing the temporal and spatial resource utilization efficiencies.

The present invention comprises aspects of AgriPAL that deals with maximizing space utilization efficiencies, which include three dimensional, 3D, soil-less, SanSSoil, plant growing structures and subsystems to sustain growth. More specifically, the aspects that reduce the cost of said structures and subsystems which lead to the minimization of the parameter f in Eq. (2). Even more specifically, the increase of gₑη_{E} which is a function of the n, the number of vertical layers in 3D farming systems wherein the yield is measured in units of ton/hectare-meter, or ton/m3, or kg/m3.

Prior Art Agriculture Methods

As is well known, since its invention, agriculture is generally practiced in the form depicted in FIG. 1A, comprising the essential elements of food production: i)—the sun; ii)—2D field, an area covered with soil that mechanically and physiologically support plant growth; and iii)-water irrigation source, and nutrients. This is referred to as arable land that combines adequate quantities of sun, water, and nutrients which generally come at no cost. The supplemental nutrients or fertilizers, when added, carry a relatively low cost. As demonstrated by AgriPAL described in FSA, this form of farming has been profitable because the main ingredients come at little or no cost.

In recent years, the adoption of indoor controlled environment agriculture, CEA has increased. An exemplary prior art reference is U.S. Pat. No. 3,931,695 which gives a good description of CEA. In CEA, the growth area is sheltered, making the control of many plant growth parameters possible, thereby achieving higher yields and higher resource utilization efficiencies. The increased use of soil-less hydroponic or aeroponics nutrient delivery practices increased the economic viability for growing many plants. FIG. 1B illustrates the elements of CEA, also referred to as greenhouse. When solar illumination is used, CEA is the same as conventional sheltered farming with the added benefit of protection from the weather and better control of pesticides, nutrients, and water. When temperature control is added, yields can be enhanced and many planting cycles become possible year round. When artificial lighting is used, extending growth periods to 24 hours per day becomes possible.

Applying AgriPAL has shown that this growing method of farming, while growing in acceptance, is economically viable for certain high value added plants. It is not possible to economically (profitably) produce staple crop or biofuel us indoor farming because of the added daily energy consumption for heating or cooling, and the cost of the added infrastructure. The objects of FSA and present invention are inventive aspects that make indoor farming viable even for staple foods.

Most recently, Van Gemeret et al. taught 3D farming system in US Publication 2011/0252705, Oct. 20, 2011 which is depicted in FIG. 1C. The system resembles stacking many edifice floors vertically, resembling the greenhouses in FIG. 1B but placed one on top of the other. The most prominent features of this vertical farming concept are: i)—higher productivity per unit area; ii)—the plants in each floor are independent of the plants of neighboring floors; iii)—the floors do not share resources (light nutrients) directly; iv)—constrained to use only artificial lighting; and v)—the ceiling height, h, of each floor makes the system highly inefficient in terms of productivity per unit height. The economic viability is possible only for high value added products like tulips, cut flower, etc. As will be shown in more details, the present invention addresses these limitations, by means of making growth layers in the form of networked strings that are coupled to each other sharing light, and nutrients, thereby compressing the vertical height needed for growth by factors ranging from 5 to 50.

There are numerous other proposals for 3D vertical farming, but none addressed the issues of cost reduction, understanding photosynthesis energy efficiency, vertical space utilization efficiency, and other resource efficiencies in order to make staple food and biofuel production economically feasible. More specifically, they do not meet the AgriPAL profitability condition, Eq. (2) except for very high priced products, i.e., for

$$\frac{\overline{ROE}}{\overline{COE}} > 100.$$

FIGS. 1D-1H illustrate prior art plant growing methods having distinct environments, (elements) 50a-50e, each of which comprises, a plant 53 illuminated by the sun 51. They are distinguished by the type of growing medium, the plant to mechanical support, and the method of delivering nutrients to the plants. In the case of elements 50a, 50b and 50e, the soil provides the support and nutrients are delivered directly to the soil which are them up taken by plant roots.

In the case of element 50c, the hydroponic method well known in the art is used comprising, a mechanical structure 54, (container) for growing one or more plants. The container is filled intermittently (or continuously) with nutrients 55, and the plant up takes the nutrient through a porous root support structure, 52a. This root support structure replaces soil.

The aeroponics method, 50d, also known in the art, comprises a plant support structure 56, through which the roots penetrate to bottom space 57c, where the roots are sprayed directly by means of nozzle 57. This method is known to achieve better yields than the soil based and the hydroponic systems because the roots are in direct contact with the ambient oxygen. Its main disadvantage is the low vertical space utilization efficiency and the spray nozzle clogging. In all the cases, the roots are feed by a plurality of different physically separated components (discrete instead of integral components). Also all of these elements feed the roots indirectly from the bottom.

Another key aspects of the present invention is an integrally formed growing element called SanSSoil Growing Element, SGE. It is self-sufficient in the sense that it integrates many essential functions for growth in the smallest space and a lowest cost. One distinguishing feature is the direct delivery of nutrients to the plant root from top down, instead of spaying the root from the bottom up. The integral multifunction constructs of the SGE's enable their connection into strings and 3D network of strings that will save space and resources by sharing resources. The inventive aspects of the SGE are key reason for cost reduction to enable staple economical food farming satisfying AgriPAL condition even when

$$\frac{\overline{ROE}}{\overline{COE}} \sim 1.$$

The construction and functions of the SGE and their interconnection into networks of strings are the main object of the present invention.

The network of strings, forming multi-layer 3D systems, is further distinguished from prior art by the inventive permeability feature of said multi-layers. Layer permeability is defined as the ability to pass through to neighboring layers, light (transparency) and nutrients, received from other neighboring layers. In addition, the shoots and roots of one layer may pass thorough neighboring layers. This enables the roots of one layer to share the space of the shoots of a neighboring layer below it. The end result is high utilization efficiency of the vertical space. The light transparency feature reduces the number of artificial illumination sources as well as the energy consumption.

Liabilities of Soil Based Outdoor Agriculture

In the above, we discussed the high cost of the involuntary dependence on solar energy; enticed by the zero cost to ensure economic viability outdoor farming. One of the consequences is forcing conventional agronomy to succumb to accepting ˜0.5% and as low as 0.1% efficiency. This afforded little or no control over the energy efficiency, η_{E}, to make further improvements beyond what has already been achieved in the last 50 years, ˜20 times yield improvements, the fruits of the Green Revolution that started in 1950s.

Going forward, perhaps only fractional gains may be realized, which are offset by higher per capita demand. The low efficiency and lack of control of outdoor solar-based and soil-based farming have lead to the requirement of enormous resources that are used inefficiently including: insatiable demand for two dimensional arable land, water, fertilizers, and pesticides.

In Section II of my Co-pending FSA, I presented a number of examples highlighting the challenges associated with growing staple commodity foods indoors, and why that is not possible if one relied of the limited prior art understanding of the efficiency, η_{E}, concluding that outdoor field soil-based farming is the only presently available viable option for growing staple food to feed the world, and growing biofuel, energy for transportation.

This viable outdoor option is for the continuous reliance on the zero cost solar energy, and its associated drawbacks or requiring vast resources that are not utilized efficiently. In addition, the outdoor farming constraint, subjects the growers to other consequences; environmental and economic risks, unexpected crop losses due to microscopic pathogens, weeds, droughts, floods, and extreme unseasonable temperature variations.

### OBJECTS OF THE INVENTION

In order to solve the formidable food and energy problems and challenges facing humanity and eliminating the contradictory conflicts, a transformational departure from conventional agricultures is needed. Conventional agricultures is constrained to be in the outdoor open field environment. This constraint is a consequence of the reliance on zero cost of solar energy, CO2, and water for photosynthetic to produce biomass for food and energy. The path to the solutions of the aforementioned problems is abandoning outdoor soil-based agriculture that requires enormous supplies of arable lands and water resources. Following this new path provides great benefits which include: eliminating the lack of control over nutrients, 1000 times water saving, eliminating adverse environmental conditions, and soil-borne pathogens.

Instead of conventional two dimensional, 2D, outdoor farming, the object of this invention is to teach means and methods to profitably harness the third dimension where unlimited space is available, where soil is avoided, and water can be conserved. The inventive 3D agriculture according to the present invention focuses on utilizing the third dimension efficiency by teaching devices, systems and methods to compress the vertical space needed for food production.

The teachings according to the present invention of 3D farming is the partitioning of the third dimension into a plurality of layers (multi-layers) each of which is capable of being supplied with nutrients, and the light needed to sustain growth. Said plurality of layers are supported by means of a 3D structure that comprises a master system comprising subsystems which are designed to optimally provide water, light, nutrients, CO2, O2, and temperature controls for specific plant organism species.

Said plurality of layers comprise strings of interconnected soil-less (SanSSoil) growth elements, SGEs, each of which is integrally made to have a multi-function capability including: germinating the seed, growing the plant, providing the plant with physical structural support, water, nutrient, light, and capability to sense the plant environment.

The strings of SGEs are disposed in the first, second and third spatial coordinates. They are in the form of one dimensional network, two dimensional network or three dimensional network supported by the multilayer structure.

An aspect of the invention is resource utilization efficiency such that staple foods and bio-energy are produced profitably so that the food and energy supplied with no “food or fuel” competition problem. This is accomplished by means of inventive features described herein that enable the plants in each SGE in string networks to share resources including: light, nutrients, and intra-layer space. This is the multi-layer permeability property taught according to the present invention.

Another aspect of the present invention is making the each SGE and the string interconnection and space between strings optically transparent, permeable, so as to enable light to pass through plurality of layers to share, conserve and efficiently utilize light. This will minimize the need for many light sources, thereby reducing product cost.

Another aspect of the present invention is avoidance limitations of prior art method of growing plants to reduce cost to enable economical staple food production.

Another aspect of the present invention is saving vertical, intra-layer space by enabling the plant root and plant shoot sharing. This means the roots of plants one layer, can occupy (share) the space of the shoots (leaves) of the layer below.

Another aspect of the present invention is providing a totally sealed system for growing plants for food and energy comprising inventive sealing features and mechanisms to recycle water and nutrient resources to maximize utilization efficiency and reducing cost. For example, the natural transpiration of water is recaptured and reused. The plant growth environment is maintained at a desired temperature and relative humidity for optimum plant performance. The result is water saving by reutilizing between 100-1000 times water which would have been wasted in conventional outdoor agriculture.

Another aspect of the present invention is the benefits of sealed 3D growing system that include the avoidance of the unpredictable weather conditions which results in a reliable food production with losses due to weather. The sealed growing 3D system can be made aseptic, pathogen free, adding yet another path to profitability assurance.

Another aspect of the present invention is the isolation of the sealed 3D growing system from the external environment thereby protecting said environment. This is especially beneficial when growing genetically transformed plant species (GMO) for experimental and production purposes.

Yet another aspect of the present invention is the ability of one layer to water, and nutrients from the strings of SGE in said layer, to strings of SGEs in the plurality of lower layers. This is a unique feeding mechanism that is distinct from well know prior art hydroponic and aeroponics mechanisms

Yet another aspect of the present invention is the utilization of artificial lighting, preferably LED, instead of solar lighting. More specifically, LED lighting that is delivered to the plants as pulses of short duration, between 0.1 ms and 2.5 ms, and frequencies between 30 Hz and 300 Hz. Applicant discovered that the enzymatic kinetics of the plant physiology can be made 4-10 times more efficient by temporal control the light.

Yet another aspect of the present invention is the control of the spatial placement of LED illumination sources within the 3D growing system in order to maintain uniform illumination received by the growing plants.

### BRIEF DESCRIPTION OF THE DRAWINGS

The following drawings are intended to describe the preferred embodiments and operating principles. They are not intended to be restrictive or limiting as to sizes, scales, shapes or presence or absence of certain necessary components that are not shown for brevity but are, nonetheless, well known to those skilled in the art.

FIGS. 1A-1C describe prior art farming methods: Outdoor soil based farming, Indoor CEA (greenhouse) farming and 3D vertical farming FIGS. 1D-1H illustrate the various environments which plants grow into and specifically how nutrients are delivered to the plant roots.

FIG. 2A illustrates a SanSSoil indoor farming system comprising a protected environment for sustaining plant growth, and a control subsystem that follows a program to control the growth.

FIG. 2B-2C shows more details of the system 1, that is comprised of multilayer each of which comprises a network of strings of SanSSoil Growth Elements, SGEs. The graph shows the localization of each element in the 3D space, first, second and third spatial coordinates, and how they periodically repeat with periods pz, py, pz.

FIG. 2D-2E describe more details how each SGE is made, its structures and function.

FIGS. 2F-2K describe how SGE are interconnected into strings, which in turn from layers of plurality of strings all networked to from a 3D growing system 1.

FIGS. 3A-3H describe the integrally made single SGE and its commutations with its neighbors sharing resources: light and nutrients to support growth.

FIGS. 3I-3M describe the integrally SGE and SGE strings assuming growth plants in various orientations.

FIG. 3N illustrates the possibility that strings of SGE may interconnected into series and parallel network combinations in communication with resource supply sources.

FIG. 3P shows exemplary plurality of configurations to attach SGE to supply sources, and to neighboring SGEs.

FIG. 4A describes multi-layer permeability of light, enabling layers to share light from common source.

FIGS. 4B-4C describe the multi-layer permeability of shoots, and roots sharing space of neighboring layers.

FIG. 4D illustrates the multi-layer permeability to fluids delivering nutrients to plants from a common source. The fluids are in the form of fog, mist, sprays, and streams.

### DESCRIPTION OF THE PREFERRED EMBODIMENTS

In my co-pending FSA, I described transformational new paradigm for agriculture can be realized to solve the problems facing humanity and achieve food and plat based energy security. One key feature of the new paradigm is the understanding the profitability conditions of farming. This has been accomplished by the formulation of Agriculture Profitability Assurance Law, AgriPAL, It is repeated here as EQ. (2)

$${η}_{E} ( \frac{{ɛ}_{sol}}{{ɛ}_{other}} ) \frac{\overline{ROE}}{\overline{COE}} \geq ( 1 + p + f + v ) . \qquad ( 2 )$$

AgriPAL enables an enterprise to predict profitability of plant growing systems, to prices, and to identify efficiency bottlenecks.

The economic viability index, EVI, is defined as:

$$EVI ≡ {η}_{E} ( \frac{{ɛ}_{sol}}{{ɛ}_{other}} ) = {η}_{E} {g}_{solar} .$$

This links for the first time the economic parameters of farming, profit, p, fixed cost, f, variable cost, v, to the physiological parameters of organisms (plants, algae, other phototrophs), energy conversion efficiency, η_{E}, including a gain factor,

$${g}_{solar} = ( \frac{{ɛ}_{sol}}{{ɛ}_{other}} ) ,$$

wherein, εₛₒₗ, is the solar energy consumed per cycle and, εₒₜₕₑᵣ, all other energies consumed.

An enhanced EVI, was derived from a the new Plant Growth Model, PGM, also described in FSA, is given by: EVI^{e}≡η_{E}^{e}≡gₑη_{E}. This increases the efficiency by yet another gain factor, gₑ, which can be 10-100, achieved by means of controlling and optimizing physiological growth parameters as well maximizing the temporal and spatial resource utilization efficiencies.

The present invention comprises aspects of AgriPAL that deals with maximizing space utilization efficiencies, which include three dimensional, 3D, soil-less, SanSSoil, plant growing structures and subsystems to sustain growth. More specifically, the aspects that reduce the cost of said structures and subsystems which lead to the minimization of the parameter fin Eq. (2). Even more specifically, the increase of gₑη_{E} which is a function of the n, the number of vertical layers in 3D farming systems wherein the yield is measured in units of ton/hectare-meter, or ton/m3, or kg/m3.

The preferred embodiments, in the present application, deal with growing plants in 3D space that is limitless. More specifically, 3D space including, growing plants in 3D edifices, structures, or towers of heights, ranging from 10 meter to 100 meters, and even more preferably tower heights beyond 100 meter perhaps approaching 500 meter or even 1000 meter. Building having heights exceeding 500 m already exist. It is also known that making wind turbine tower as high 150 m is economical feasible

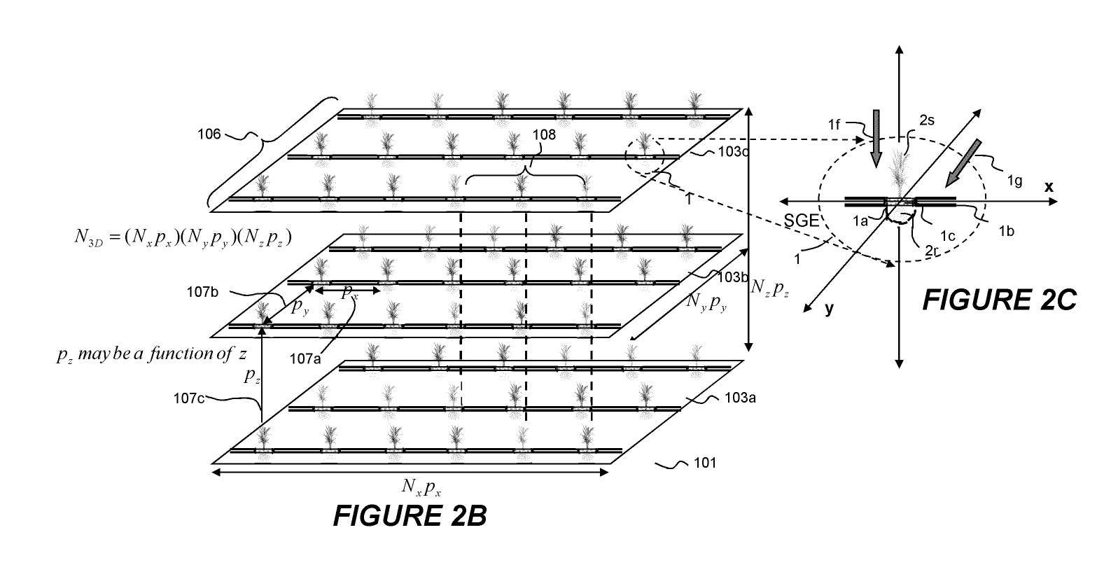

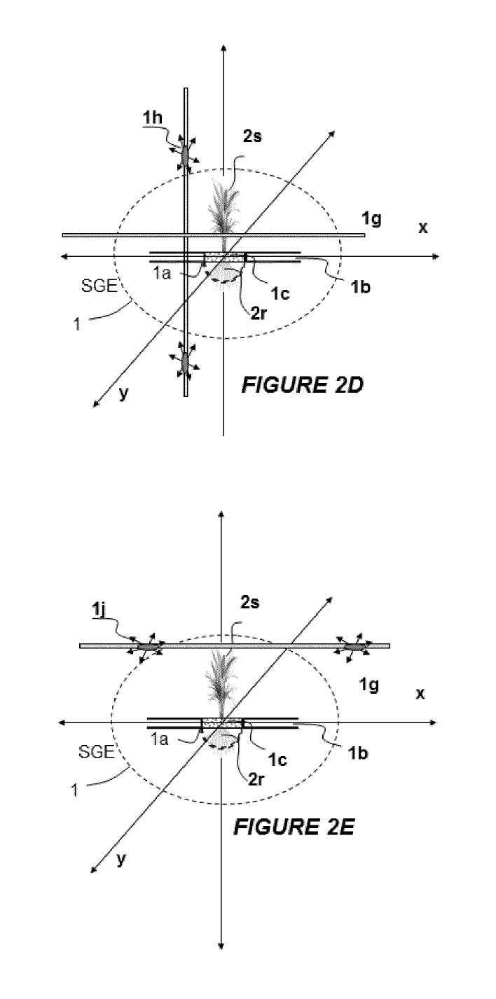

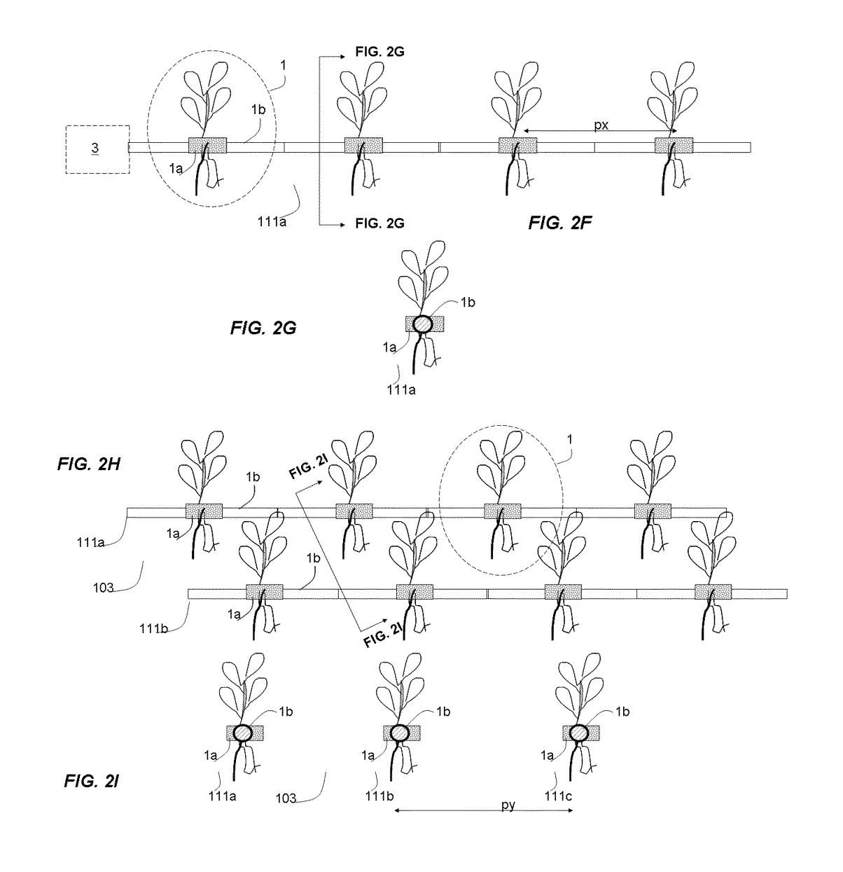

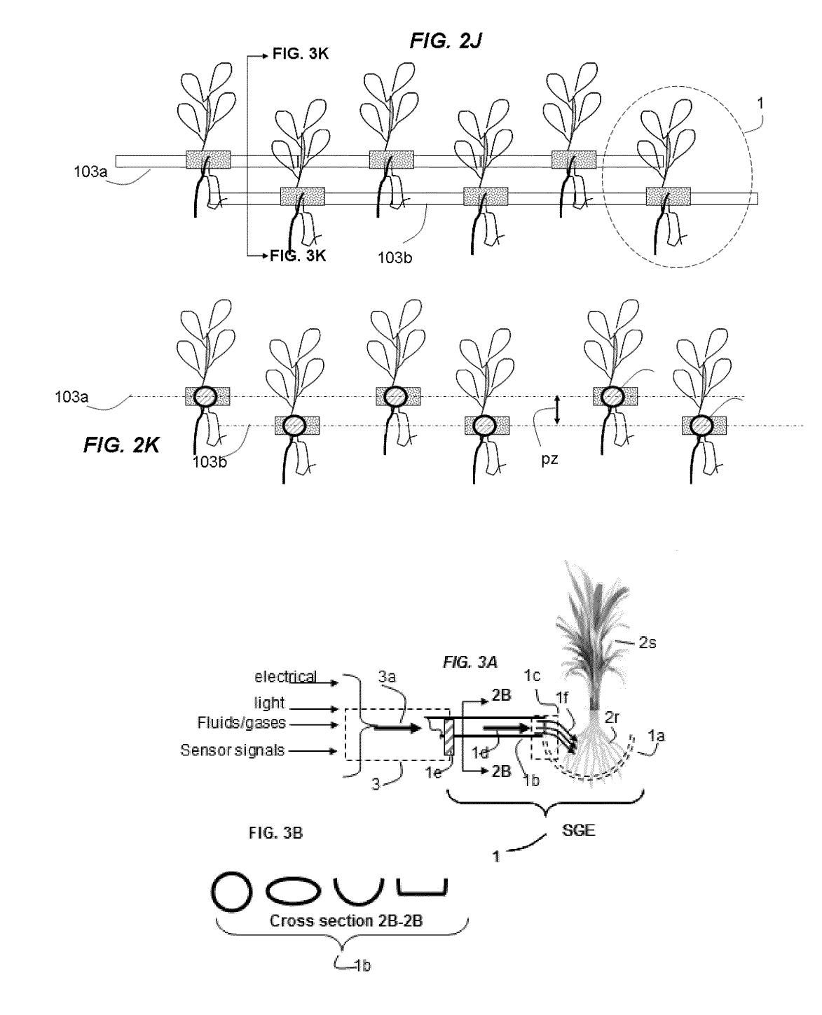

FIG. 2A is an exemplary depiction of an indoor SanSSoil farming system 100 comprising a SanSSoil sheltered and protected controlled environment 101 and a control subsystem 102. The SanSSoil sheltered and protected controlled environment 101 is designed to be substantially impermeable to pests, and undesired gases, liquids, particulates, and other foreign objects. Preferably said protected environment is well insulated and protected from outside temperature swings in order to maintain a desired temperature that is most suitable for growth and results in maximum productivity.

In certain situations, solar radiation may augment artificial light for photosynthetic growth. In this case the SanSSoil environment 101 may be equipped with filters to filter out unwanted solar wavelengths including ultra-violet, infra-red and certain visible wavelengths.

The hybrid growth method based on the combination of artificial lighting, preferably LED, with selected solar wavelengths will enable the maximization of gₑgₛₒₗₐᵣ, viability index and the profit margins established through meeting the AgriPAL condition as described in FSA

The SanSSoil environment also comprises structures for handling seed/seedling input 105 harvested product output. Said structures are preferably designed to incorporate appropriate sealing structures such as load locks in order to maintain sterile or near sterile conditions. Means to achieve impermeability and sterility of SanSSoil edifices are well known to persons skilled in the art. Internally, the SanSSoil environment 101 houses a plurality of SanSSoil plant culture layers 103 disposed in a three dimensional space. The SanSSoil plant layers are made form structures and materials that are optically transparent. This will enable the layers share and recycle unabsorbed light, thereby increasing the light energy utilization efficiency.

The control subsystem 102 is programmed to control all aspects of growth physiology to achieve economic viability by ensuring that

$${EVI}^{e} = {g}_{e} {η}_{E} = ( {G}_{sp} {G}_{t} {G}_{f} ) ( {\prod }_{i = 1}^{n} {g}_{i} ) {η}_{E}$$

approaches 1 in order for AgriPAL condition to be satisfied. Each gain parameter in the portfolio has an optimum range that gives the maximum value. This is adjusted by the subsystem 102 for each species. The upper and lower limits of this range are determined experimentally in optimized environmental parameters.

In some situations, a group comprising more than one interacting parameters, may be adjusted and optimized together. For example, adjusting the carbon dioxide to an optimum value limited by the dark reaction enzyme density requires adjusting the light level until it is limited by the light reaction enzyme density. The steps of optimization are aided by appropriate sensors which communicate with the controller values to require adjustments.

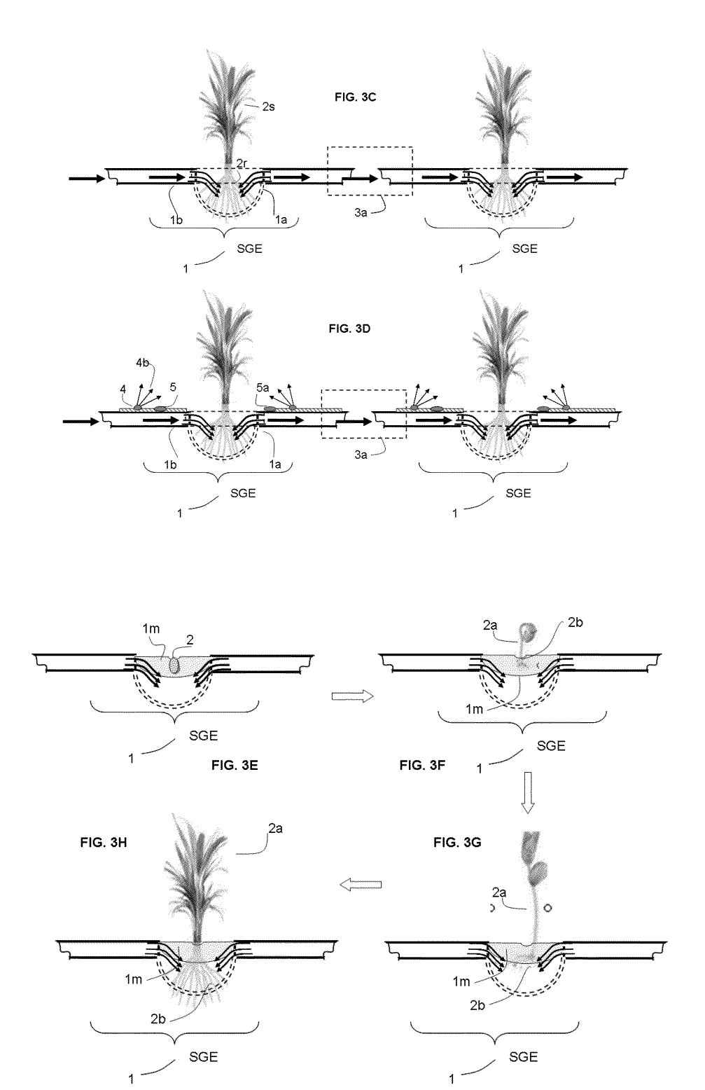

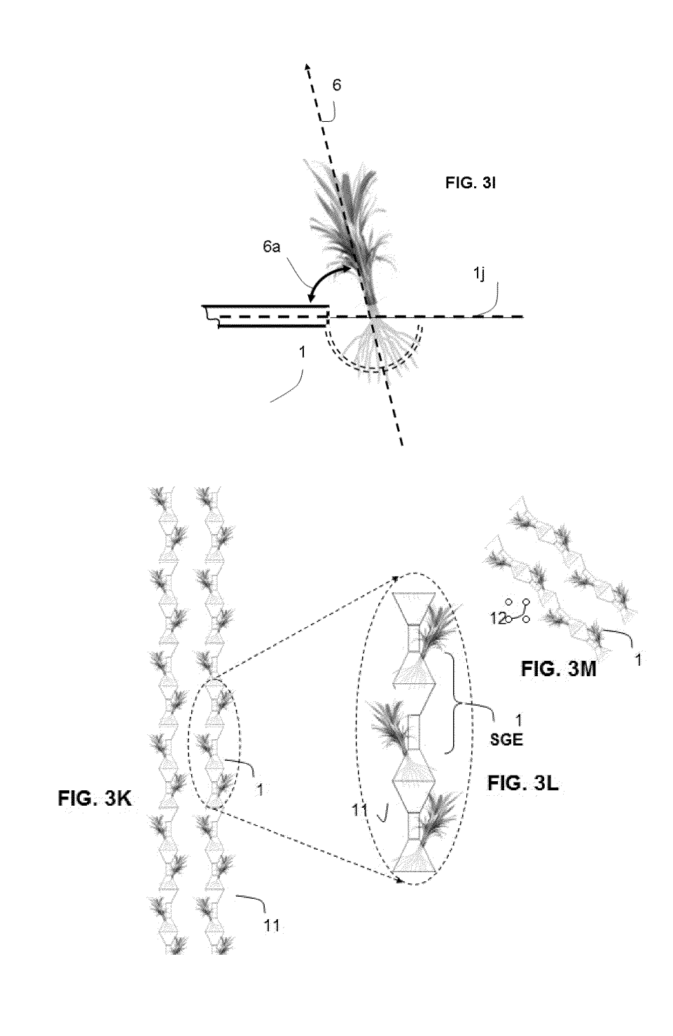

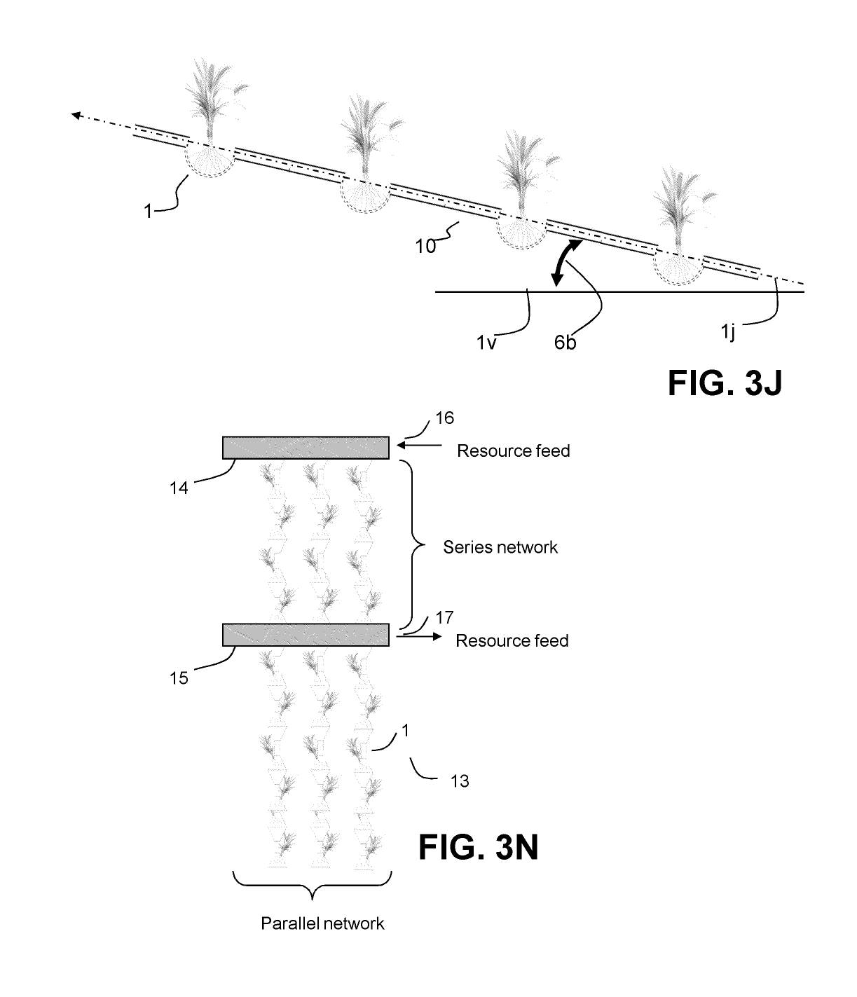

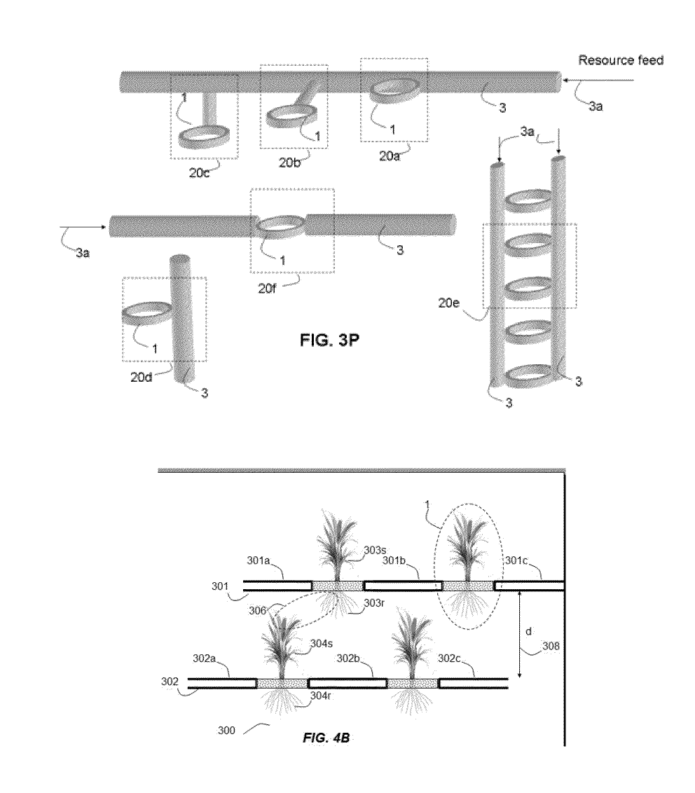

Each layer 103 within the SanSSoil environment 101, is so designed to sustain the growth of plants or organisms in integrally made SanSSoil growth elements (modules), SGE 1, described further in FIGS. 2B-2K, and FIGS. 3A-3P. The layers 103 and the plurality of SGE's are spaced in such a manner that optimizes the space utilization efficiency Gₛₚ.

Each SGE 1, comprises integrally made structure 1a, 1b which houses the plant 2, the shoot 2s, and the root 2r, and connected to a nutrient sources 3, 3a. The nutrients drip or spray downward on the root in the cup like substructure. One key aspect of the present invention is to combine this method of feeding, with foliar feeding, well known in the art, by means of fogging subsystem (or mist) which preferably supplies micron scale fluid particles (droplets) that are absorbed directly by the plant leaves, by-passing root uptake. Each SGE 1, optionally and integrally comprises a light source 4, and a sensor 5.

It is also possible to have two fogging systems, one for supplying one set (a first set) of nutrients to the root and a second supplying different nutrient set to the leaves. In addition to providing more than one feeding sources, it is contemplated that in certain situations, said source may be applied sequentially, or in a temporally pulsed manner with adjustable periods and duration.

This inventive feature is unique to indoor farming, according to the present invention, because it affords a new degree of freedom for the subsystem 102 to control the components of gain factor gₑ, through optimization of the operating range of each component. This is especially advantageous when two sets of nutrients are antagonistic to each other, competing to prevent the optimum pH to establish for maximum beneficial uptake.

FIG. 2B shows that in each of layers 103a, 103b, and 103b, the SGE's (FIG. 2C) are connected in strings 106, that are connected to nutrients sources delivered to each SGE site. In the first spatial coordinate, x, the SGE repeat at period px, 107a, while the strings repeat in the second coordinate, y, at a period py, 107b. In the third spatial coordinate, z, the layers repeat at period pz, 107c. The dashed lines 108 depict columns of SGEs in their respective layers. The total number of plants in the 3D system, N_{3D}=(Nₓpₓ)(N_{y}p_{y})(N_{z}p_{z}), determines the overall 3D productivity of the system 100.

The illumination sources 1h, 1j and auxiliary sensors, 1g, or other resource, are disposed in any orientation relative to the three spatial coordinates, FIGS. 2C-2E.

As shown in FIG. 2F, a plurality of SGEs are connect as a linear string 111a, which is connected to a sources 3. The connection structures are so designed to deliver with high conductivity nutrients to each site 1. Preferably, these structure are designed for quick connection to the SGE, enabling rapid and inexpensive and automated means to form a long string. These structures also have the strength to spurt the weight of the plants in the string. FIG. 2G shows a cross section of the string.

In FIG. 2H, many strings 111a, 11b, are placed in parallel to form a layer 103. The cross section FIG. 2I illustrated an important feature of the present inventions which is the empty space between strings. This enables the sharing of nutrients, light that pass through between the strings and between the layers.

The advantages of the string interconnections is further highlighted in FIGS. 2J-2K wherein two layers 103a, 103b disposed vertically, each comprising a plurality of strings. One immediately notices the space saving in the cross section FIG. 2k where the plants of layer 103b, is in the space of the top layer 103a. The space between two layers is pz. It will be show later in a different embodiment that the period pz can be made to vary depending on the age of the plant manually or automatically.

Now we provide in FIGS. 3A-3P more specific details of the construction of the SanSSoil Growth Element, SGE. The term integral multifunction is defined as a structure that comprises at least two substructures integrally made substantially permanently attached so as to carry out at least two functions. The our preferred embodiment said functions are chosen from the group: {mechanical support, growth sustenance, germination, self-supplying nutrients, self-supplying light, sensing environment, communication nutrients to nearest neighbor}.

The SGE in FIG. 3A comprises growth compartment or substructure 1a which mechanically and physiologically supports the growth of the root 2r and the shoot to maturity. The substructure 1a is integrally attached to a connecting conduit 1b, that is in fluid communication with growth substructure 1a, through orifice or opening 1c. Fluid 1d, flows through said orifice 1c, supplying a stream 1f to the root. Conduit 1b may have any cross section as shown in FIG. 3B.

Conduit 1b is removably attached to at least one source 3. Said attachment is preferably quick connect disconnect type with sealing function to prevent leakage, 1e. The source 3 provides essential resources, ingredients, to optimally sustain plant growth. Said resources comprise at lease water and nutrients, but may also conduct and deliver light by means of total internal reflection mechanisms, well known in the fiber optic art and the back-light sources well know in the liquid crystal display art. The conduit may conduct electrical signals or power from sensors and to local LEDs ingrated directly into the conduit 1b.

Conduit 1b according to FIGS. 3C-3D, serves to connect two SGEs to form strings as described above, FIGS. 2K-2K, and to pass resources 3a from one SGE to another. Said resources include fluids, conducting signals from sensors 5, 5a, and energizing LEDs 4, to provide illumination 4b to local plants.

As shown in FIGS. 3E-3H, the SGE in the preferred embodiment also comprises a seed support structure l1, which functions to mechanically support the seed 2, and to provide the optimal environment for high germination rate. By following the arrows in the figures, we show the emergence of the shoot 2a and root 2b to growth of the seedling and finally the mature plant. This emphasizes the significance of the integral construction of the SGE according to this preferred embodiment highlighting the capability multi-functions which comprise: mechanical support of seed and mature plant, germination, local nutrient delivery, local delivery of light, environment sensing, and growing plant to maturity, FIG. 3D.

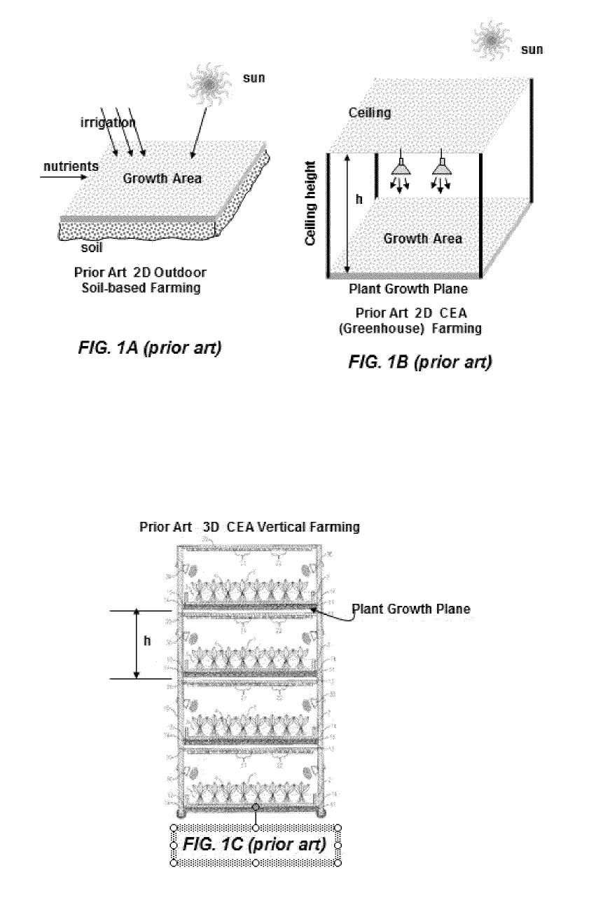

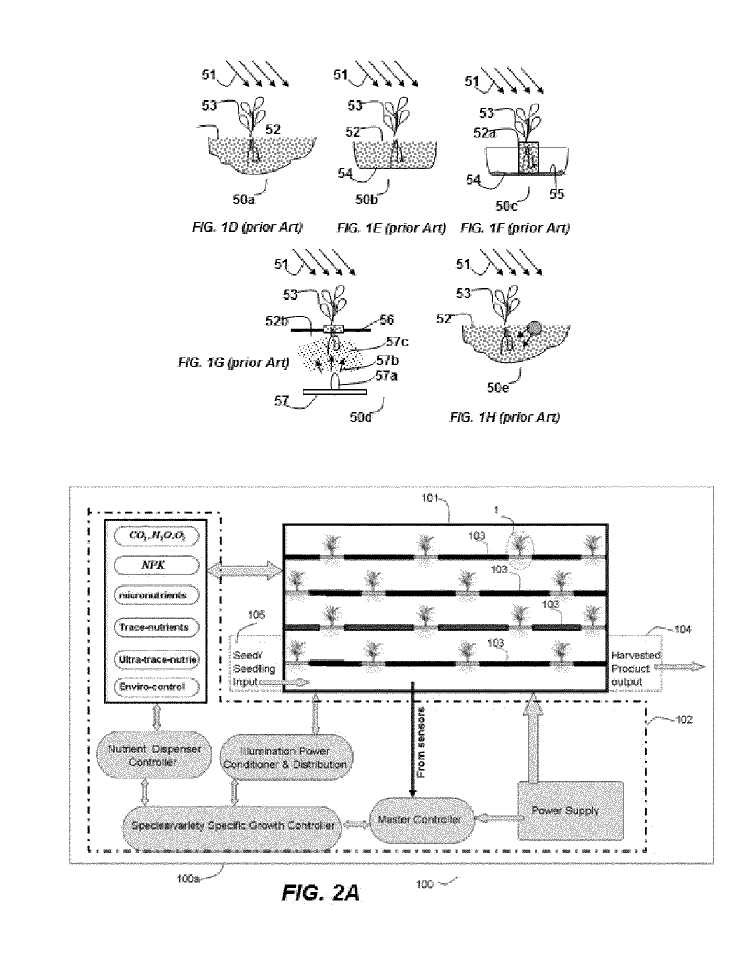

The multi-function integral construction of SGE, also highlight the local self-sufficiency of each SGE, that plays a significant role in maximizing 3D space utilization efficiency. It also serves to make its distinction clear, relative from prior art plant growing practices described above in connection with FIGS. 1A-1H.

Since the plants follow the light direction, we can advantageously exploit this property to orient the plant growth in any desired direction as illustrated in FIG. 31, wherein the growth axis 6, makes an angle 6a with respect to the layer axis 1j. In other embodiments, the whole string and plane, 10, may be oriented at an angle 6b with respect to the horizontal direction 1v, FIG. 3J.

Yet in other embodiments, it is preferred to make strings that are hanging from top to bottom, 11, 12, with SGE oriented in desired directions determined by the light as shown in FIGS. 3K-3M.

In addition, there are system optimization benefits to interconnect SGE string in the form of a network, 13, FIG. 3N, that combines series and parallel combinations of strings attached to feeding structures, 14, 15, which receive resources 16, 17 from a master delivery system (no shown). The benefits of this arrangement include: increasing speed and flexibility of system assembly, reducing infrastructure cost, and optimizing consumable utilization efficiencies.

Integrally made multi-function self-sufficient SGE may be attached to feed structure, or string interconnection sutures, 3, in a plurality of desired configurations, 20a-20e, shown in FIG. 3P, depending on the plant species and system design requirements. Persons skilled in the art may produce other configurations, without departing from the SGE network interconnectivity claimed by the present invention.

Multi-Layer Permeability

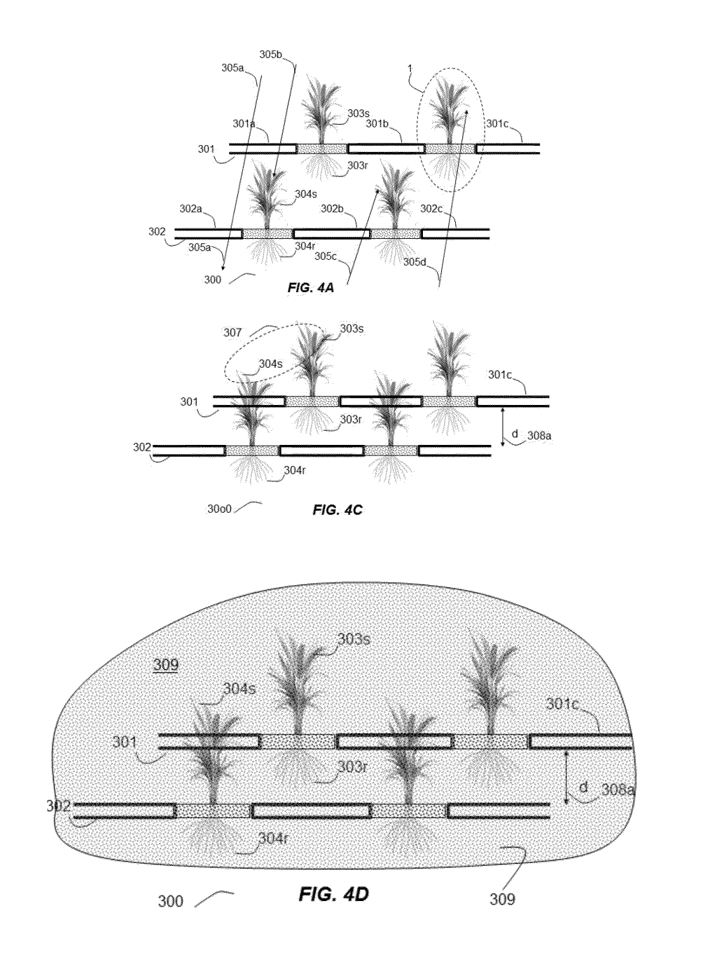

To realize the full optional of 3D multi-layer farming, the preferred embodiments comprise means to maximize resource utilization efficiencies. This is accomplished by means of sharing these resources which include: illumination sources; nutrient delivery subsystems, supporting structures, and space. The means for sharing which are described in FIGS. 4A-4D result in the reduction of the system fixed costs, f, as well as the variable consumable costs, v, thereby ensuring maximum profitability, according to AgriPAL Eq. (2) above.

The definition of permeability, according to the present invention, is the ability of a layer comprising at least one string of SGEs to pass resources from a first group of neighboring permeable layers, to a second group of neighboring permeable layers. The first and or the second group may comprise resource delivery sources. The total number of vertically disposed layers ranges from 2 to 10, and more preferably from 10 to 100 and even more preferably in excess of 100 layers.

The permeability feature of the present invention enables the sharing of resources, including water, nutrient, illumination, heating and cooling and other sharable resources. The sharing of said resources enables their efficient, use thereby minimizing the ultimate product cost. The 3D yield or 3D productivity is measured in units of weight divided by volume and units of time. Therefore, the permeable means for sharing resources are designed to produce the maximum product weight in the most compact 3D space in the shortest time. These means are described with aid of FIGS. 4A-4D.

Referring to FIG. 4A an exemplary multi-layer system 300, comprising at least layers 301, 302 which are built by stringing a plurality of SGEs 1, as described in more details above and in FIGS. 2G-2K. Layers 301, 302, and the connecting structures, 301a-301c, and, 302a-302c as well as SGE structures, are made substantially optically transparent so as to allow light rays 305a-305d from sources (not shown) to pass through layers 301, 302 to illuminate the plant shoots 303s, 304s of neighboring layers. The optical transparency of layer structure is made possible by means of transparent materials chosen from at least glass, polycarbonate, polyethylene, and polypropylene, polystyrene.

This means of achieving of light permeability enables multi-layers to share at least one light source growing plants, thereby realizing the maximum efficiency of the light source. As it may be appreciated, seedlings are small and are separated by wide lateral and vertical spaces. It takes months before the space between them is filled. During this time the light that is not absorbed by one layer, passes through to be absorbed by neighboring layers. The end result is a few light sources are used to illuminate a large number of layers. This immediately results in the reduction of initial capital cost of the light sources. For example, a 100 layer (permeable) system may be served by only one planar light source located on top of the system. By adding reflecting system walls, minimum light is wasted.

By contrast, prior art 3D farming system in FIG. 1C contemplates using one set of light sources for each layer, clearly revealing how wasteful prior art teaching is. It further validates the significance of the permeable inventive feature of the present invention.

In addition to minimizing the initial fixed cost of light sources, the permeable layers also use the consumable light energy efficiently, lowering the variable cost of production. Any light that is not absorbed by a permeable layer passes through to adjacent layers to be consumed by plants in these layers. In prior art teachings, the light energy that is not absorbed by plants is irretrievably lost as a wasted resource.

Referring to FIGS. 4B-4C, another type inventive permeability feature is described. It pertains to the roots 303r, 304r, and shoots 303s, 304s (stems, branches, leaves) of plants in one layer penetrating (sharing) the space of roots and shoots of plants in adjacent layers 306, 307. This space sharing achieves an unprecedented vertical compression, reducing the vertical height d, 308, 308a, many times. The absence of this space sharing would have required maximum height for roots which added to the maximum height of shoots, and the system would vertically less compact.

FIG. 4D illustrates yet another type of permeability, which is the ability of one layer to pass through unabsorbed nutrients to adjacent layers. Nutrients essential for sustaining optimum growth of plants are provided by sources (not shown) in the space 309 occupied by at least the multi-layers 301, 302. Exemplary sources include fogging system, spraying system, and dripping systems which intermittently fill the space 309 with nutrients. These nutrients are delivered to the plants by means of foliar feeding or root feeding. FIGS. 2G-2K, show that string of SGEs in each layer are spatially separated by empty spaces which allow the nutrients to pass from one layer to the next. This permeability also minimizes the number of feeding sources and their initial cost.

1. A Permeable 3D Multi-Layer Farming System comprising:
At least one integrally made SanSSoil growing element, SGE;
At least one means to provide resource permeability.

2. The system in claim 1, wherein the SGE comprises a means to provide multifunction self-sufficiency to sustain life of said biomass.

3. The system according to claim 1, wherein said at least one SGE is interconnected to form multi-layer three dimensional array structure disposed in a first, second and third spatial coordinates, wherein the system further comprises at least one means of resource permeability.

4. The system according to claim 3, wherein the array structure comprises: at one layer comprising a network of interconnected strings SGE wherein said at least layer is permeable to shared resources.

5. The system according to claim 3, wherein the shared resources include, illumination, heating, cooling, and nutrients.

6. The system according to claim 3, wherein the array structures comprising at least a first and second layers and a space there between, wherein the plant roots of first layer shares the space of the plant shoots of the second layer.

7. The system according to claim 3, wherein the array structures comprising at least a first and second layers and a space there between, wherein the plant shoots of the second layer, shares the space of the plant roots and shoots of the first layer.

8. The system according to claim 3, wherein the array structures comprising at least a first and second layers and a vertical space there between; and a means for compression of vertical space, wherein said means comprises layer construction so as to enable the sharing roots and shoots of plants in first and second layers.

9. The system according to claim 3, wherein the array structures comprising at least a first and second layers wherein said structures are constructed from sustainably transparent material permeable to light from at least one source.

10. The system according to claim 3, wherein the array structures comprising at least a first and second layers wherein said layers are permeable to fluids from at least one source.

11. The system according to claim 9, wherein said fluids are delivered by at least one subsystem selected from the group consisting of fogging, misting, streaming and dripping.
